(19) United States
(12) Patent Application Publication
(10) Pub. No.: US 2026/0081350 A1
(43) Pub. Date: Mar. 19, 2026

(54) ANTENNA SHIELD

(71) Applicant: Elta Systems Ltd., Ashdod (IL)

(72) Inventors: Reuven BAUER, Rehovot (IL); Amir SHMUEL, Ashdod (IL); Hillel ALPEROVITCH, Rishon Lezion (IL)

(21) Appl. No.: 19/323,189

(22) Filed: Sep. 9, 2025

(30) Foreign Application Priority Data
Sep. 18, 2024 (IL) 315730

(51) Int. Cl. H01Q 1/52; H01Q 13/28

(52) U.S. Cl. CPC H01Q 1/526; H01Q 13/28

(57) ABSTRACT

A shield is provided for an antenna, the shield including a plurality of rods, each rod having at least an external surface made from an electrical conducting material, the rods being in parallel spatially spaced relationship one to another, the rods each having a respective curved transverse cross-section. Also provided is an antenna installation, including an antenna and such a shield. The antenna has a forward antenna face for emitting and/or receiving electromagnetic radiation. The shield is spaced forward of the forward antenna face by a forward spacing.

### TECHNOLOGICAL FIELD

The presently disclosed subject matter relates to mechanical protection for antennas, in particular for phased array antennas.

### BACKGROUND

The inventors consider that there are many applications of antennas in which mechanical protection thereof from threats that can potentially damage, destroy or render inoperable the antennas, is required or desirable.

One example of such an antenna, in which such mechanical protection is considered by the inventors to be desirable, includes a phased array antenna.

Conventionally, providing such mechanical protection in the form of a metal shield is counter intuitive and considered to be detrimental to the operation of the antenna, as the metal shield would be expected, conventionally, to block the transmission therethrough of the electromagnetic waves transmitted from and received by the antenna.

Polarizing filters for phased array antennas are known, and are commonly in the form of dielectric substrates (such as for example epoxy glass) with thin flat metal strips printed thereon. Such filters are sometimes placed forward of a phased array antenna, and such filters can be used for polarization of electromagnetic waves emitted by the antenna, or for rotating the plane of polarization of the antenna. The width of such metal strips is maintained below 1/20^{th}, typically around 1/30^{th}, of the wavelength of the electromagnetic energy transmitted by the antenna, and the depth of the strips (in a direction orthogonal to the plane of the dielectric substrate) is significantly less than this width. Accordingly, such polarizing filters are not considered to be able to provide mechanical protection for an antenna from a threat that can potentially damage, destroy or render inoperable the antenna.

Frequency Selective Surfaces (FSS) are known in the context of radar radomes, but are conventionally considered to be unsuitable at least for phased array antennas.

### GENERAL DESCRIPTION

According to a first aspect of the presently disclosed subject matter there is provided a shield for an antenna, the shield comprising a plurality of rods, each rod at least having an external surface made from an electrical conducting material, the rods being in parallel spatial relationship one to another, the rods each having a respective curved transverse cross-section.

In at least some examples, the external surface covers a dielectric core, while in at least some other examples, the rods are made from the same or different electrical conducting materials.

For example, the shield is in the form of a parallelepiped, having a forward face and an aft face, the shield having a lateral length dimension, a height dimension, and a thickness dimension.

Additionally or alternatively, for example, in said parallel spatial relationship the rods are spaced from one another by respective gaps, wherein said inter rod gaps are empty. Alternatively, for example, in said parallel spatial relationship the rods are spaced from one another by respective gaps, and wherein said gaps are filled, partially or fully, with a suitable dielectric material.

Additionally or alternatively, for example, each said rod is elongate and extends rectilinearly along a respective longitudinal axis between a respective first longitudinal end and a respective second longitudinal end. For example, in said parallel relationship, the respective longitudinal axes of the rods are parallel to one another.

Additionally or alternatively, for example, each said curved transverse cross-section has a baseline height dimension. For example, each said curved transverse cross-section is circular, and wherein the baseline height dimension is a baseline diameter of the transverse cross-section. Alternatively, for example, each said curved transverse cross-section is egg-shaped oval or elliptical, and wherein the baseline height dimension is a dimension of a respective minor axis of the respective egg-shaped oval or elliptical transverse cross-section.

Additionally or alternatively, for example, each said rod has a uniform said transverse cross-section along the length thereof.

Additionally or alternatively, for example, all the rods comprised in the shield have the same cross-sectional baseline height dimensions.

Additionally or alternatively, for example, an operating frequency of the antenna is 4.8 gigahertz, and the baseline height dimension is about 6 mm (i.e., 6 mm±2mm), or about 8 (i.e., 8 mm±2mm), or in the range between about 6 mm to about 8 mm; alternatively, for example, an operating frequency of the antenna is 2.4 gigahertz, and the baseline height dimension is about 12 mm (i.e., 12 mm±2mm), or about 16 mm (i.e., 16 mm±2mm), or in the range between about 12 mm to about 16 mm.

Additionally or alternatively, for example, said rods are made from one or more materials and are so dimensioned and so shaped so as to together provide physical characteristics sufficient such as to provide mechanical protection to the antenna when the shield is interposed between the antenna and a source of an in-coming threat. For example, said physical characteristics include one or more of: mechanical strength, ductility, toughness, thickness, density, of the material.

Additionally or alternatively, for example, said rods are made from a mechanically resistant metal.

Additionally or alternatively, for example, said rods are made or comprise any one of or combination of steel, stainless steel, tungsten, chromium, titanium, iron.

Additionally or alternatively, for example, said baseline height dimension is significantly greater than 1/20^{th} of the respective operating minimum wavelength of the antenna.

Additionally or alternatively, for example, said baseline height dimension is less than or about ⅛^{th} or less than a respective operating minimum wavelength of the antenna, and wherein said baseline height dimension is greater than 1/20^{th} of the respective operating minimum wavelength of the antenna.

Additionally or alternatively, for example, the longitudinal axes of the respective said rods accommodated in the shield are fully included in planar aligned arrangement with respect to a single plane. For example, the single plane is orthogonal to a propagation direction of an electromagnetic beam transmitted and/or received by the antenna at zero azimuth and 0° elevation. Additionally or alternatively, for example, in said single plane an inter-rod center spacing between adjacent longitudinal axes of each respective pair of adjacent rods is in the order of ¼ of the respective operating minimum wavelength of the antenna. For example, the inter-rod center spacing is about 30 mm.

Additionally or alternatively, for example, the longitudinal axes of the respective said rods accommodated in the shield are divided into a number of groups, wherein in each said group the respective longitudinal axes are included in planar aligned arrangement with respect to a respective plane of a plurality of mutually parallel planes. For example, each said respective plane is orthogonal to a propagation direction of an electromagnetic beam transmitted and/or received by the antenna at zero azimuth and 0° elevation. Additionally or alternatively, for example, in said respective plane an inter-rod center spacing between adjacent longitudinal axes of each respective pair of adjacent rods is in the order of ¼ of the respective operating minimum wavelength of the antenna. For example, the inter-rod center spacing is about 30 mm. Additionally or alternatively, for example, each pair of adjacent said planes are spaced from one another by an inter-plane spacing, and wherein the inter-plane spacing is in the order of ¼ of the respective operating minimum wavelength of the antenna. For example, wherein the inter-plane spacing is about 30 mm. Additionally or alternatively, for example, for each pair of adjacent said planes, the respective rods of one said adjacent plane are in staggered arrangement with respect to the respective rods of the other said adjacent plane. For example, in said staggered arrangement, each of the rods of one said adjacent plane are intercalated with respect to an adjacent pair of said rods of the other said adjacent plane. For example, in said staggered arrangement, each of the rods of one said adjacent plane are intercalated with respect to an adjacent pair of said rods of the other said adjacent plane by an intercalation spacing equal to half of the inter-rod center spacing between adjacent longitudinal axes of each respective pair of adjacent rods. For example, in said staggered arrangement, each of the rods of one said adjacent plane are intercalated with respect to an adjacent pair of said rods of the other said adjacent plane by an intercalation spacing less than half of the inter-rod center spacing between adjacent longitudinal axes of each respective pair of adjacent rods.

Additionally or alternatively, for example, the shield comprises a frame structure configured for mechanically fixing the rods in said parallel spatial relationship one to another. For example, the frame structure includes a first frame member laterally spaced from a second frame member, each in orthogonal relationship with respect to the respective longitudinal axes of the rods, and wherein the rods are mechanically fixed to the first frame member via the respective first longitudinal ends of the rods, and wherein the rods are mechanically fixed to the second frame member via the respective second longitudinal ends of the rods. For example, the frame structure further comprises a top frame member and a bottom frame member, each joined at respective lateral ends thereof to the first frame member and the second frame member. For example, the frame structure comprises one or more thin cross-sectioned intermediate vertical members, each said thin cross-sectioned intermediate vertical member linking the top frame member and the bottom frame member to one another. Additionally or alternatively, for example, the frame structure is made from any suitable dielectric material or from a metal. Additionally or alternatively, for example, the rods are mounted to the frame via a first shock absorber arrangement.

Additionally, or alternatively, for example, the shield comprises one or more dielectric sheets, in nominally parallel relationship with respect to a forward face of the shield, the one or more dielectric sheets being configured for providing a level of protection to the antenna. For example, the shield comprises at least one of the following: one said dielectric sheet affixed to the forward face; one said dielectric sheet fixed to an aft face of the shield; at least one said dielectric sheet fixed within the shield.

Additionally, or alternatively, for example, the shield comprises a foam material filling spaces between the rods.

According to a second aspect of the presently disclosed subject matter, there is provided an antenna installation, comprising:
an antenna having a forward antenna face for emitting and/or receiving electromagnetic radiation;
a shield as defined herein regarding the first aspect of the presently disclosed subject matter, spaced forward of said forward antenna face by a forward spacing.

For example, the shield is operative for providing protection to the antenna for threats originating in a direction towards the forward antenna face, wherein said direction is included within a channel defined by a respective maximum azimuth range and an elevation range of the antenna.

For example, the respective maximum azimuth range is ±60°, and the respective maximum elevation of the antenna is ±60°.

Additionally or alternatively, for example, the channel diverges and increases a cross-sectional area thereof in a direction away from the forward antenna face, in particular in a forward direction away from the forward antenna face.

Additionally or alternatively, for example, a height dimension of the shield and the length dimension of the shield are such as to ensure that the respective rods fully traverse a length and a height of a cross-section of the channel corresponding to a location of the shield in the channel.

Additionally or alternatively, for example, the channel is defined by a top surface, a bottom surface, a right side surface and a left side surface, wherein a height dimension of the shield is such that the top surface of the channel intersects an uppermost said rod of the shield, and such that the bottom surface of the channel is any one close to abutting, or intersecting, a lowermost said rod of the shield, and wherein a length dimension of the shield is such that the right side surface and the left side surface of the channel each intersect all of the rods of the shield.

Additionally or alternatively, for example, the antenna installation includes a protection structure configured for providing at least protection from a threat having a trajectory towards the antenna that avoids crossing into the channel and that is towards the antenna. For example, wherein the protection structure comprises a peripheral wall and a top wall. Additionally or alternatively, for example, the antenna installation comprises a second shock absorber arrangement interconnecting the shield to the protection structure.

Additionally or alternatively, for example, the antenna is any one of:
a static phased array antenna;
a static radio antenna or a static TV antenna;
a revolving antenna, in which the shield is mechanically coupled to the antenna, and wherein the shield and the antenna revolve as a unit about the rotation axis of the antenna.

Additionally or alternatively, for example, the antenna is any one of: a passive electronic scanned array (PESA); an active electronically scanned array (AESA); a hybrid beam forming phased array; a digital beam forming (DBF) array; or a conformal antenna in which individual antennas are arranged on a curved surface, and phase shifters operate to enable the conformal antenna to generate a plane wave.

Additionally or alternatively, for example, the antenna is operative to generate a steerable radio beam having a propagation direction, the radio beam having an oscillating electric field along an electric field plane, and wherein said longitudinal axes of the respective rods are non-parallel with respect to the electric field plane.

Additionally or alternatively, for example, said radio beam is operable at a radio frequency range in any one or more of the X-band, S-band, C-band, or L-band.

According to a second aspect of the presently disclosed subject matter, there is provided a method for protecting an antenna, the antenna having a forward antenna face for emitting and/or receiving electromagnetic radiation, the method comprising:
providing a shield as defined herein regarding the first aspect of the presently disclosed subject matter;
spacing the shield forward of said forward face.

A feature of at least one example of the presently disclosed subject matter is that a shield is provided for enabling an antenna to be mechanically protected at least from a threat, for example a threat that can potentially damage, destroy or render inoperable the antenna.

Another feature of at least one example of the presently disclosed subject matter is that a shield is provided for enabling an antenna to be mechanically protected. Another feature of at least one example of the presently disclosed subject matter is that a shield is provided, particular for use with a phased array antenna.

### BRIEF DESCRIPTION OF THE DRAWINGS

In order to better understand the subject matter that is disclosed herein and to exemplify how it can be carried out in practice, examples will now be described, by way of non-limiting example only, with reference to the accompanying drawings, in which:

FIG. 1A is a side view of a static antenna according to an aspect of the presently disclosed subject matter; FIG. 1B is a top view of the antenna example of FIG. 1A.

FIG. 2 is an isometric view of a shield according to a first example of the presently disclosed subject matter; FIG. 2A is a front view of an example of a rod comprised in the shield example of FIG. 2; FIG. 2B is a cross-sectional view of the rod example of FIG. 2A taken along A-A.

FIG. 3A is a top view of an example of an antenna installation, including the antenna example of FIGS. 1A, 1B, and the shield example of FIGS. 2, 2A, 2B; FIG. 3B is a cross-sectional side view of the example of FIG. 3A, taken along B-B; FIG. 3C is an isometric view of the example of FIG. 3A.

FIG. 4 is an isometric view of the shield example of FIGS. 2, 2A, 2B.

FIG. 5 is a cross-sectional side view of an example of a rod arrangement for the shield example of FIGS. 2, 2A, 2B.

FIG. 6 is a cross-sectional side view of another example of a rod arrangement for the shield example of FIGS. 2, 2A, 2B.

FIG. 7 is a cross-sectional side view of another example of a rod arrangement for the shield example of FIGS. 2, 2A, 2B.

FIG. 8 is a cross-sectional side view of another example of a rod arrangement for the shield example of FIGS. 2, 2A, 2B.

FIG. 9 is a cross-sectional side view of another example of a rod arrangement for the shield example of FIGS. 2, 2A, 2B.

FIG. 10 is a cross-sectional side view of another example of a rod arrangement for the shield example of FIGS. 2, 2A, 2B.

### DETAILED DESCRIPTION

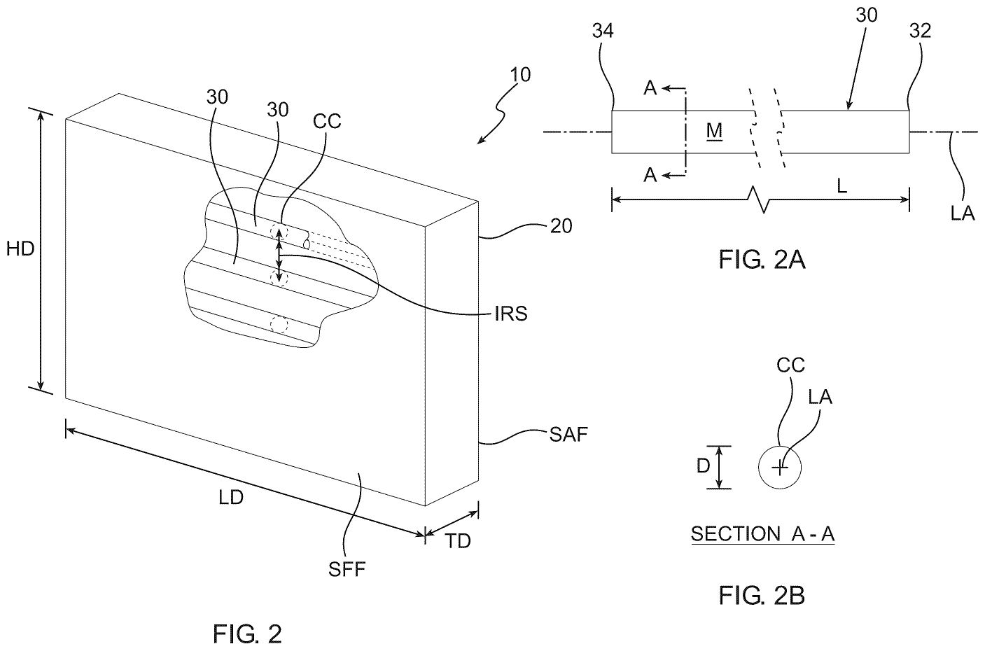

According to a first aspect of the presently disclosed subject matter, and referring to FIG. 2, a shield (also referred to herein interchangeably as a mechanical shield or as an antenna shield) according to a first example, generally designated with reference numeral 10, comprises a plurality of rods 30, the rods 30 being in parallel spatial relationship one to another.

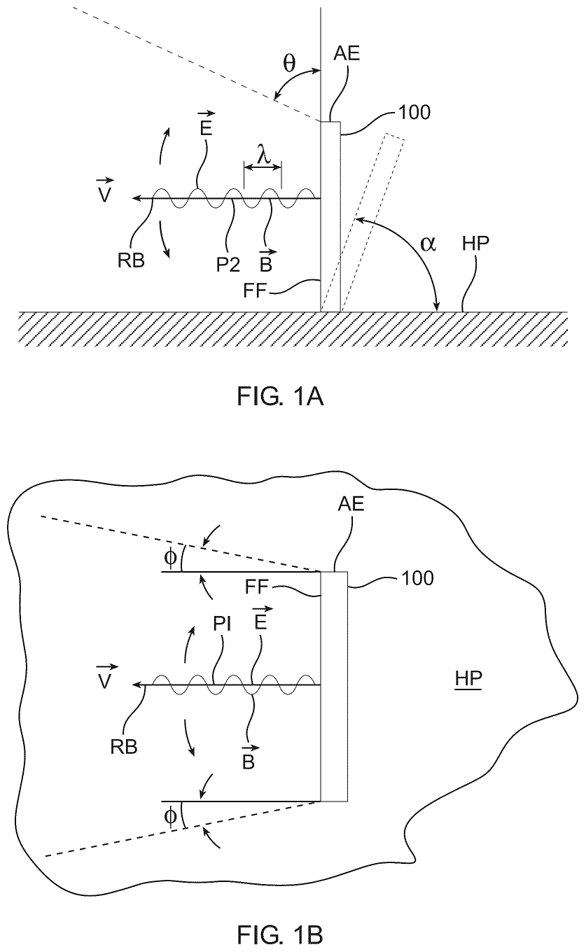

In at least one example, and referring also to FIGS. 1A and 1B, the shield 10 is for use with an antenna 100 that operates to transmit and/or receive electromagnetic energy. Furthermore, while in at least this example, the antenna 100 is a static phased array antenna, in at least some other examples, the respective antenna can be any other suitable antenna, for example a static antenna, for example a static radio antenna or static TV antenna. In yet other examples, the respective antenna can be any other suitable antenna, for example a revolving antenna, in which the shield is coupled to, and revolves with, the antenna.

For example, the antenna 100 can be any one of: a passive electronically scanned array (PESA); or an active electronically scanned array (AESA); or a hybrid beam forming phased array; or a digital beam forming (DBF) array; or a conformal antenna in which individual antennas are arranged on a curved surface, and phase shifters operate to enable the conformal antenna to generate a plane wave. In yet other examples the antenna can be a non-phased array antenna, for example.

In at least this example, the antenna 100 comprises a plurality of antenna elements (not shown) within an antenna envelope AE and which operate in a conventional manner to generate at least one beam RB of electromagnetic energy in the form of radio waves in a forward direction with respect to the antenna 100, and to steer the beam RB in azimuth and elevation. For example, the azimuth and elevation can be defined with respect to a global angular coordinate system, in which elevation angle is defined relative to the horizon, while azimuth angle is orthogonal to the elevation angle but also defined relative to the horizon. For example, the antenna 100 can be operated to steer the beam RB in azimuth and elevation within a respective maximum azimuth range ±f and a respective maximum positive elevation q (i.e., a respective elevation range from 0° (nominally horizontal, parallel to the horizon) to the maximum positive elevation q above the horizon) or within a respective maximum elevation range ±q (i.e., a respective elevation range spanning between above and below the horizon).

For example, such an antenna envelope AE comprises a forward face FF, through which the radio beam RB exits the antenna 100 and into which reflected radio beams are received by the antenna 100.

In at least this example, the antenna envelope AE is generally orthogonal to a horizontal plane HP, such as for example the ground, and the forward face FF is thus orthogonal to the horizontal plane HP.

However, in at least some alternative variations of this example, the antenna envelope AE, and thus the forward face FF, can be inclined at a desired inclination angle α with respect to the horizontal plane HP, as shown by the dotted line in FIG. 1A for example.

The radio beam RB has a propagation direction V, which in operation of the antenna 100 can be steered in azimuth and elevation as disclosed above, the propagation direction being generally rectilinear.

The radio beam RB, which is typically a polarized beam of electromagnetic energy, has an oscillating electric field E along a first plane P1, and a perpendicular oscillating magnetic field B along a second plane P2, wherein the first plane P1 is perpendicular with respect to the second plane P2.

In at least this example, the first plane P1 is vertical, and thus also orthogonal to the horizontal plane HP. The orientation of the first plane P1 on the horizontal plane HP varies with the azimuth angle of the radio beam RB. The second plane P2 is at an angle with respect to the horizontal plane HP that varies according to the elevation angle of the radio beam RB.

In at least various implementations of at least this example, the respective antenna 100 can operate in a suitable radio frequency (or radio frequency range) and corresponding operating wavelength λ (or corresponding wavelength range Rλ). While such a radio frequency (or corresponding frequency range) can be in any one or more of: the L-band (frequency range 1 GHz to 2 GHz), S-band (frequency range 2 GHz to 4 GHz), C-band (frequency range 4 Ghz to 8 GHz), X-band (frequency range 8 GHz to 12 GHz), UHF band, or VHF band, the following examples will be based on operation of the antenna 100 in the S-band.

Referring again to FIG. 2, the shield 10 comprises a frame structure 20 that is configured for mechanically fixing the rods 30 in said parallel spatial relationship one to another. In said parallel spatial relationship the rods 30 are spaced from one another by respective gaps IRG providing corresponding inter-rod spacings IRS. The inter rod gaps IRG can be empty (i.e., is open to the atmospheric environment) or can be filled, partially or fully, with a suitable dielectric material, for example.

In at least this example, the shield 10 (and in at least this example, also the frame structure 20) is in the form of a parallelepiped, having a rectangular forward face SFF and a rectangular aft face SAF, each having a lateral length dimension LD and a height dimension HD, and separated by a thickness dimension TD.

Referring also to FIG. 2A, each rod 30 is elongate, having a longitudinal length L, and extends rectilinearly along a respective longitudinal axis LA between a respective first longitudinal end 32 and a respective second longitudinal end 34. In said parallel relationship, the respective longitudinal axes LA of the rods 30 are parallel to one another.

In at least some examples, the longitudinal length L is about 2200 mm, in other examples, the longitudinal length L can be 7 m to 9 m.

In general, the length L is a predetermined length greater than the width of the antenna 100.

Referring in particular to FIG. 2B, each rod 30 also has a curved transverse cross-section CC. In at least this example, each respective cross-section CC of the plurality of rods 30 in the shield 10 is circular. However, other suitable curved cross sections are also possible. For example, in at least some alternative variations of this example, the curved cross-section CC can instead be similar to an egg-shaped oval, or can be elliptical, for example. In the case of an egg-shaped oval cross section, the major axis thereof (corresponding to the axis of symmetry of the cross section) is aligned with or parallel to the propagation direction V at least at one elevation angle of the radio beam RB, for example at 0° elevation angle (i.e., horizontal). Similarly, in the case of an elliptical cross section, the major axis of the cross section is aligned with or parallel to the propagation direction V at least at one elevation angle of the radio beam RB, for example at 0° elevation angle (i.e., horizontal).

In at least this example, each rod has a uniform cross section along the length thereof, and all the rods 30 have the same cross-sectional size, for example the same diameter, referred to herein as a baseline cross-sectional height; in this example, in which the rods have a circular cross-section, the baseline cross-sectional height is in the form of a baseline diameter D. However, in at least some alternative variations of this example, the respective rods can have different diameters (or different sized minor axes of the respective cross sections, in cases where the respective cross-sections CC are egg-shaped oval or elliptical) one from the other, within a range, and in which the maximum diameter (or respective minor axis) of the rods in such a range is of a size corresponding to the above mentioned baseline height dimension, or baseline diameter D.

In at least some examples, the baseline height dimension, or baseline diameter D, is about 12 mm. In at least one example, the operating frequency λ is 2.4 gigahertz, and the baseline height dimension is about 12 mm or 16 mm, or in the range 12 mm to 16 mm.

In at least some other examples, the baseline height dimension, or baseline diameter D, is about 6 mm. In at least one example, the operating frequency λ is 4.8 gigahertz, and the baseline height dimension is about 6 mm or about 8 mm, or in the range 6 mm to 8 mm.

The longitudinal length L of each rod 30 is much greater than the respective baseline height dimension or baseline diameter D thereof. For example, the ratio L/D of the longitudinal length L to the respective baseline height dimension or baseline diameter D is greater than 10, for example 600 to 900.

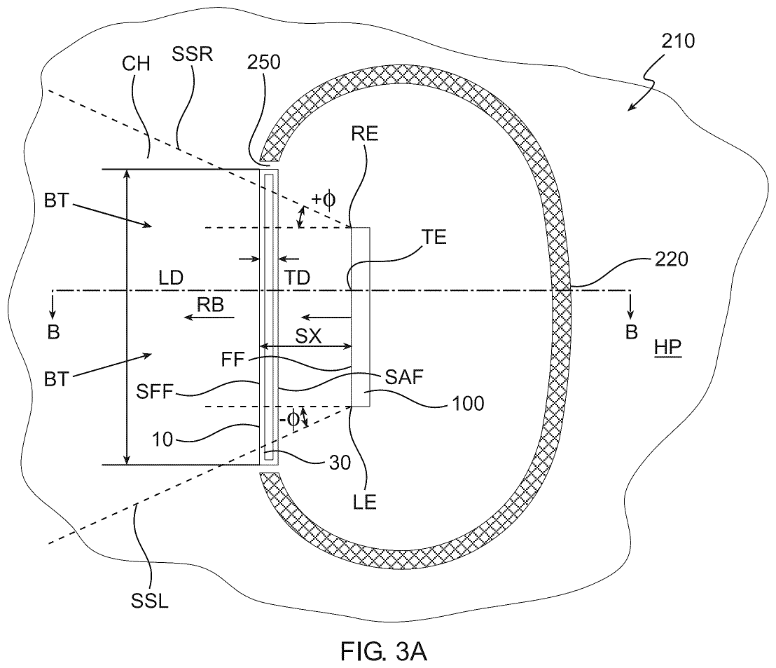

In at least this example, the rods 30 are made from one or more materials M and are so dimensioned and so shaped so as to together provide physical characteristics, in particular mechanical characteristics, such as to provide protection to the antenna 100 when the shield 10 is interposed between the antenna 100 and the source of an approaching threat (FIGS. 3A, 3B).

According to an aspect of the presently disclosed subject matter, each rod 30 has an external surface 35 made from an electrical conducting material ME such as for example a metal.

In at least some examples, such one or more materials M includes a dielectric core, coated or otherwise surrounded by an external layer of an electrical conducting material ME, such as for example a metal. The dielectric core materials and the electrical conducting material are chosen such that, when so-shaped and so-dimensioned according to the presently disclosed subject matter, the rod has physical characteristics, in particular mechanical strength, that are sufficient to provide protection to the antenna 100 when the shield 10 is interposed between the antenna 100 and the source of an in-coming threat.

In other examples, such one or more materials M includes an electrical conducting material ME, such as for example a metal, chosen such that, when so-shaped and so-dimensioned according to the presently disclosed subject matter, it has physical characteristics, in particular mechanical strength, that are sufficient to provide suitable mechanical protection to the antenna 100 when the shield 10 is interposed between the antenna 100 and the source of an in-coming threat.

Such physical characteristics, in particular such mechanical characteristics, can include one or more of mechanical strength, ductility, toughness, thickness (corresponding to the respective baseline height dimension or baseline diameter D), density, and so on, of the material M or of electrical conducting material ME, which contribute to enable the rods 30 made from the material M (and optimally of electrical conducting material ME) to provide high resistance-to-impact damage, and thus an ability to withstand the impact of such a threat, or to mitigate the damage effects on the antenna 100 of such an impact.

Thus, such physical characteristics also include electrical conductivity on at least the outer facing surface 35 of the respective rods 30.

By threat is meant herein to include inter alia a plurality of elements, for example low-mass, high velocity elements, wherein for example each such element has a characteristic dimension, for example diameter, for example in the range of several millimeters to several centimeters, for example up to about 5 cm and that such a plurality of on-coming elements, in the absence of the shield, would be expected to cause damage to the respective antenna to a degree at least sufficient to impair or prevent operation of the antenna, or to a degree that could destroy the antenna. For example, such elements can include bullets from small arms to heavy machine guns, or vehicles that are directly guided to the antenna, or the like.

By “protection” (also interchangeably referred to herein as “mechanical protection”) is meant that the rods 30 are configured for stopping such elements when impacting onto the rods 30, and/or deflecting such elements when impacting onto the rods 30, and/or for absorbing sufficient impact energy when impacting onto the rods 30, such as to avoid mechanically damaging the antenna 100, or at least such as to minimize damaging the antenna 100, such that the antenna is able to function to transmit and/or receive electromagnetic waves, and/or, such that the antenna 100 can be easily and quickly repaired in-situ.

According to an aspect of the presently disclosed subject matter, the respective baseline height dimension or baseline diameter D is significantly greater than 1/20^{th} of the respective operating wavelength λ (i.e., D>>0.05*λ) of the antenna 100. In applications of at least this example, in which the respective antenna 100 operates in an operating wavelength range Rλ, the respective baseline height dimension or baseline diameter D is significantly greater than 1/20^{th} of minimum wavelength λ_{MIN} of the respective operating wavelength range Rλ (i.e., D>>0.05*λ_{MIN}).

According to this aspect of the presently disclosed subject matter, the respective baseline height dimension or baseline diameter D is as large as possible to provide maximum mechanical strength to the respective rod 30, and thus maximize protection provided by the rod 30, and at the same time the respective baseline height dimension or baseline diameter D is about ⅛^{th} or less of the respective operating wavelength λ (i.e., D £ 0.125*λ), but still significantly greater than 1/20^{th} of the respective operating wavelength λ (0.050*λ<<D £ 0.125*λ). In applications of at least this example, in which the respective antenna 100 operates in an operating wavelength range Rλ, the respective baseline height dimension or baseline diameter D is as large as possible to provide maximum mechanical strength to the respective rod 30, and thus maximize protection provided by the rod 30, and at the same time the respective baseline height dimension or baseline diameter D is about ⅛^{th} or less of the respective minimum wavelength λMIN of the respective operating wavelength range Rλ (i.e., D £0.125*λ_{MIN}), but still significantly greater than 1/20^{th} of the respective minimum wavelength λ_{MIN} of the respective operating wavelength range Rλ (0.050*λ_{MIN}<<D £ 0.125*λ_{MIN}).

In yet other examples, the respective baseline height dimension or baseline diameter D can exceed about ⅛^{th}, for example up to about ¼ of the respective wavelength λ or of the respective minimum wavelength λ_{MIN}; however, and without being bound to theory, inventors consider that there can be a degradation of the signal of the beam, and some of the electromagnetic energy transmitted and/or received via the shield can be reflected by the shield.

According to this aspect of the presently disclosed subject matter, the respective baseline height dimension or baseline diameter D is as large as possible to provide maximum mechanical strength to the respective rod 30, and thus maximize protection provided by the rod 30, and at the same time the respective baseline height dimension or baseline diameter D is a proportion N, or less than proportion N, of the respective operating wavelength λ, wherein the proportion N is greater than 0.05 and also less than or equal to any one of the following values: 0.12; 0.11, 0.10; 0.09; 0.08; 0.07; 0.06. In applications of at least this example, in which the respective antenna 100 operates in an operating wavelength range Rλ, the respective baseline height dimension or baseline diameter D is as large as possible to provide maximum mechanical strength to the respective rod 30, and thus maximize protection provided by the rod 30, and at the same time the respective baseline height dimension or baseline diameter D is a proportion N, or less than proportion N, of the respective minimum wavelength λ_{MIN} of the respective operating wavelength range Rλ, wherein the proportion N is greater than 0.05 and also less than or equal to any one of the following values, or any other value between the following values: 0.12; 0.11, 0.10; 0.09; 0.08; 0.07; 0.06.

According to this aspect of the presently disclosed subject matter, the respective baseline height dimension or baseline diameter D is as large as possible to provide maximum mechanical strength to the respective rod 30, and thus maximize protection provided by the rod 30, and at the same time the respective baseline height dimension or baseline diameter D is a proportion N, or less than proportion N, of the respective operating wavelength λ, wherein the proportion N is included in any one of the following ranges of values: 0.12 to 0.05; 0.11 to 0.05; 0.10 to 0.05, 0.09 to 0.05; 0.08 to 0.05; 0.07 to 0.05; 0.06 to 0.05. In applications of at least this example, in which the respective antenna 100 operates in an operating wavelength range Rλ, the respective baseline height dimension or baseline diameter D is as large as possible to provide maximum mechanical strength to the respective rod 30, and thus maximize protection provided by the rod 30, and at the same time the respective baseline height dimension or baseline diameter D is a proportion N, or less than proportion N, of the respective minimum wavelength λ_{MIN} of the respective operating wavelength range Rλ, wherein the proportion N is in included in at least one of the following ranges of values: 0.12 to 0.05; 0.11 to 0.05; 0.10 to 0.05, 0.09 to 0.05; 0.08 to 0.05; 0.07 to 0.05; 0.06 to 0.05.

In at least this example, rods 30 including the outer surfaces 35 thereof are made from a resistant metal, for example any one of or combination of steel, stainless steel, tungsten, chromium, titanium, iron.

Referring to FIG. 3A, FIG. 3B and FIG. 3C, an antenna installation 210 includes a shield 10 and an antenna 100 spaced therefrom by spacing SX. In at least some examples, the spacing SX is about 500 mm, while in other examples the spacing SX can be much higher.

It is to be noted that the shield 10 is configured for providing protection to the antenna 100 for threats originating in a direction towards the forward face FF of the antenna 100, in particular, in such a direction included within a channel CH defined by the respective maximum azimuth range ±f and the respective maximum positive elevation q of the antenna 100 (i.e., and the respective elevation range from 0° (nominally horizontal) to the maximum positive elevation q).

The channel CH is thus generally defined by the scan volume of the antenna, i.e., the maximum azimuth range and maximum elevation range that can be provided by the antenna.

The channel CH can thus be defined by any suitable combination of maximum azimuth range and maximum elevation.

In at least some examples, the respective maximum azimuth range is ±30°, and the respective maximum elevation of the antenna 100 is +40°. In yet at least some other examples, the respective maximum azimuth range is ±60°, and the respective maximum elevation of the antenna 100 is ±60°.

The channel CH thus diverges and increases its cross-sectional area in a direction away from the forward face FF of the antenna 100.

Thus, for example, the channel CH can be defined by four imaginary surfaces as follows:
a top surface ST, projecting forward and upward of the front face CC at the top edge TE thereof at an elevation angle equal to the maximum positive elevation q of the antenna 100;
a bottom surface SB, defined by the horizontal plane HP, corresponding to a respective elevation of 0°;
a right side surface SSR on the right hand side of the antenna envelope AE, projecting forward and to the right of the front face CC at the right edge RE thereof at an azimuth angle equal to the maximum positive azimuth +f of the antenna 100;
a left side surface SSL on the left hand side of the antenna envelope AE, projecting forward and to the left of the front face CC at the left edge LE thereof at an azimuth angle equal to the maximum negative azimuth −f of the antenna 100.

In at least some alternative variations of this example, and in which the lower edge LE of the front face FF is elevated from the horizontal plane HP, such that the beam RB can be steered to a negative elevation angle, the respective bottom surface SB is instead projecting forward and downward of the front face CC at the bottom edge BE thereof at an elevation angle equal to the maximum elevation q (less than 0°) of the antenna 100. Such cases can include, for example, where the antenna is located on top of a building, hill or mountain in which a look-down capability is required or desired. In at least some such examples, the respective maximum azimuth range is ±30°, and the respective maximum elevation of the antenna 100 is ±40°. In yet at least some other examples, the respective maximum azimuth range is ±60°, and the respective maximum elevation range of the antenna 100 is ±60°.

The antenna 10 is positioned forward of the forward face FF of the antenna 100, by a forward spacing SX.

Furthermore in at least this example, the antenna installation 210 includes any suitable protection structure 200 configured for providing protection, for the sides, back and top of the antenna 100, and coming from other directions not included within the channel CH. In other words, the protection structure 200 is configured for providing mechanical protection from threats having a trajectory towards the antenna 100 that does not cross into the channel CH and is nevertheless towards the antenna 10. For example, the protection structure 200 can be in the form of a bunker or hardened shell, having a peripheral wall 220 and top wall 240. For example, the protection structure 200 can be made from reinforced concrete, stone, steel plates, and so on.

In at least some alternative variations of this example, the protection structure can instead be in the form of a cave, or other natural formation such as an overhang, or for example a number of man-made static or mobile structures arranged around the aft and sides of the antenna, outside the channel CH.

In at least some alternative variations of this example, the protection structure can be omitted. This can be the case, for example, where no threat is considered to be able to originate from outside the channel CH, or where the risk of such a threat is considered minimal, or where there is insufficient time to provide such a protection structure prior to operating the antenna.

The minimum size of the shield 10, in particular the frame 20, generally depends on the magnitude of the forward spacing SX, as well as on the scan volume of the antenna defined by the channel CH.

For a given channel CH, the greater the forward spacing SX, the greater the length dimension LD and the height dimension HD need to be, in proportion to the respective maximum positive elevation q or in proportion to the respective maximum positive azimuth +f or respective maximum negative azimuth −f, respectively. Conversely, the smaller the forward spacing SX, the smaller the length dimension LD and the height dimension HD need to be, in proportion to the respective maximum positive elevation q or in proportion to the respective maximum positive azimuth +f or respective maximum negative azimuth −f, respectively.

In such cases, the peripheral dimension of the peripheral wall 220 can be such as to provide a forward opening 250, and such that the peripheral wall 220 is as close to, but without traversing into, the channel CH, in particular the right side surface SSR or left side surface SSL thereof. The height dimension of the peripheral wall 220, and the forward extent of the top wall 240 are such that the peripheral wall 220 and the top wall are each is as close to, but without traversing into, the channel CH, in particular the top surface ST thereof. Thus, a relatively smaller forward spacing SX can enable the dimensions of the protection structure 200 to be relatively small, while a relatively larger forward spacing SX can require the dimensions of the protection structure 200 to be relatively larger.

A relatively smaller forward spacing SX can be advantageous inasmuch as the length dimension LD and the height dimension HD can be small, which in turn can result in a cheaper and lighter shield 10. Conversely, a relatively larger forward spacing SX can be expected to minimize potential damage to the antenna of any element that still manages to traverse the thickness of the shield and continues to travel towards the antenna 100, albeit with diminished momentum and diminished kinetic energy.

Thus, the magnitude of the forward spacing SX can be optimized for each application of the presently disclosed subject matter, according to the nature of the perceived threat, transport access and available area at the installation site, among other considerations.

For example, if for a particular application it is expected that there is a relatively small risk of a threat, and/or a relatively low risk of high occurrences of threats, the forward spacing SX can be relatively small, allowing the dimensions of the shield 10, in particular of the frame 20, to be relatively small. Furthermore, if the installation area around which the antenna 100 is positioned is small, and/or if transport access to the installation area is difficult or impossible for large items, then a smaller-sized frame 20 could be more optimal, and thus the forward spacing SX can be correspondingly relatively smaller.

Conversely, for example, if for a particular application it is expected that there is a relatively large risk of a threat, the forward spacing SX can be relatively large, necessitating the dimensions of the shield 10, in particular of the frame 20, to be relatively large. Furthermore, if the installation area around which the antenna 100 is positioned is relatively large, and/or if transport access to the installation area is not unduly difficult for large items, then a relatively larger-sized frame 20 could be more optimal, and thus the forward spacing SX can be correspondingly larger.

As disclosed above, the radio beam RB, which is typically a polarized beam of electromagnetic energy, has an oscillating electric field E along a first plane P1, which, in at least this example, is vertical. In other words, and at least in this example, the radio beam BM is a nominally vertically polarized beam.

In any case, and as will become clearer herein, and the rods 30 are longitudinally aligned in orthogonal relationship to the nominal polarization at the boresight position (zero azimuth, zero elevation). In other words, the longitudinal axes of the rods are orthogonal to the polarization of the radio beam RB: for example, if the radio beam RB is horizontally polarized, the rods 30 are aligned with the respective longitudinal axes vertical; for example, if the radio beam RB is vertically polarized, the rods 30 are aligned with the respective longitudinal axes horizontal; for example, if the radio beam RB is diagonally polarized (+45°), the rods 30 are aligned with the respective longitudinal axes diagonally disposed in the orthogonal direction (−45°).

According to an aspect of the presently disclosed subject matter, the rods 30 are positioned in the shield 10 with respect to the antenna 100 (at the aforesaid forward spacing SX) such that the longitudinal axes LA of the respective rods 30 are not parallel with respect to the first plane P1. In at least this example the longitudinal axes LA of the respective rods 30 are oriented orthogonally with respect to the first plane P1 when the beam RB is at zero azimuth. Concurrently the longitudinal axes LA of the respective rods 30 are parallel with respect to the second plane P2 when the beam RB is at an elevation of 0°.

Thus, in at least this example, the plurality of rods 30 of the shield 10, when the shield 10 is installed forward of the antenna 100, are oriented such that the respective longitudinal axes LA are parallel to the horizontal plane HP, for example as illustrated in FIG. 3B.

Without being bound to theory, inventors consider that having all the rods 30 oriented parallel to the first plane P1 can result in the electromagnetic waves of the beam RB “short circuiting” (causing the beam to be reflected back towards the source), and thus can prevent passage of the beam RB through the shield 10.

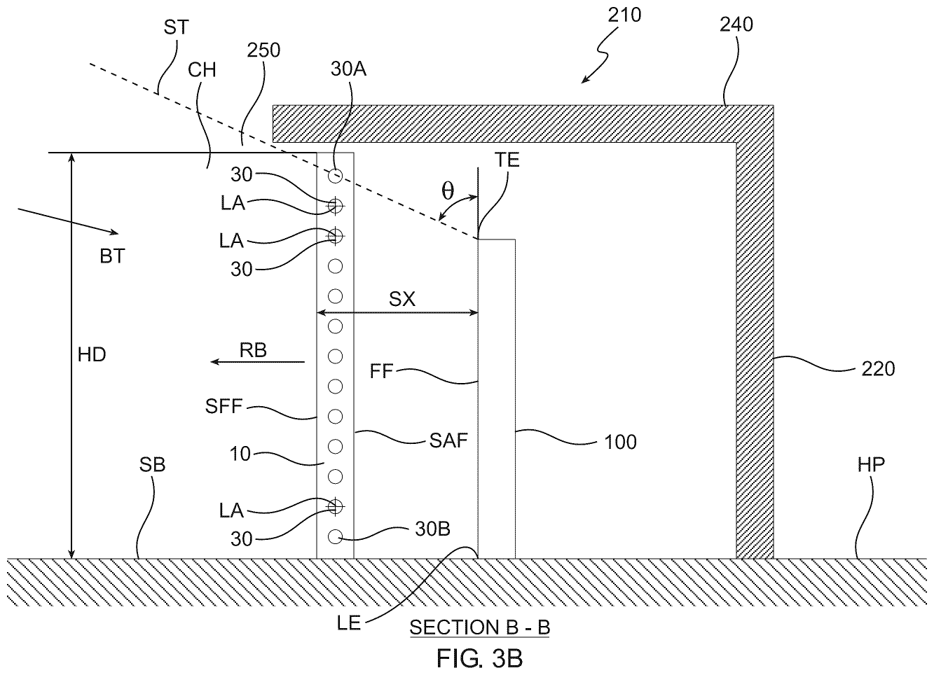

Referring to FIG. 4, the longitudinal axes LA of the plurality of rods 30 accommodated in the shield 10 can be fully included in planar aligned arrangement with respect to a single third plane P3, or can be divided into a number of groups wherein in each group the respective longitudinal axes LA are included in planar aligned arrangement with respect to a respective third plane P3 of a plurality of mutually parallel third planes P3. The one or more respective third planes P3 is/are orthogonal to the first plane P1. In at least this example, the one or more respective third planes P3 is/are orthogonal to the horizontal plane HP.

In at least this example, the frame 20 includes a left frame member 22 and a right frame member 24, laterally spaced from one another and in orthogonal relationship with respect to the respective longitudinal axes LA. The plurality of rods 30 are mechanically fixed to the left frame member 22 via the respective first longitudinal ends 32, and the plurality of rods 30 are mechanically fixed to the right frame member 24 via the respective second longitudinal ends 34.

In at least some examples, the stiffness of the rods 30 is sufficient to provide mechanical integrity of the shield 10, and maintain the spatial arrangement of the rods 30 with respect to the frame 20. However, in at least this example (and in other examples in which the stiffness of the rods 30 is insufficient to provide mechanical integrity to the shield 10 to thereby maintain the spatial arrangement of the rods 30 with respect to the frame 20), the frame 20 further comprises a top frame member 25 and a bottom frame member 26, each joined at respective lateral ends thereof to the left frame member 22 and the right frame member 24.

Optionally, one or a few relatively intermediate vertical members 28 can be provided, linking the top frame member 25 and the bottom frame member 26 together to provide further stiffness to the frame 20.

In at least some example, the intermediate vertical members 28 can be made from or covered with electrically conducting materials ME, and the intermediate vertical members 28 can also have a relatively thin cross-sectional area.

By “relatively thin” in the context of the cross-section of the intermediate vertical members 28 is meant that the cross-section of the intermediate vertical members 28 is about ⅛^{th} to about ¼ of the wavelength λ or minimum wavelength λ_{MIN} of the beam RB.

In examples in which the intermediate vertical members 28 can be made from or covered with a dielectric material, the cross-sectional area thereof can be greater.

The frame 20 can be made from any suitable mechanically strong material, for example a dielectric material, for example wood or composite materials, fiberglass, Plexiglas, rexolite, Delrin, or for example of a suitable metal, for example steel or aluminum; in other examples the frame can be constructed from honeycomb panels, for example. At least one or more of the top frame member 25, bottom frame member 26, left frame member 22 and right frame member 24 can be made from concrete, for example.

In examples in which at least the left frame member 22 and the right frame member 24, and in particular the intermediate vertical member(s) 28, are made from a metal, the relative thin or small cross-section of these frame members in relation to the cross-section of the shield 10 (along a plane parallel to the third plane P3) is very small, for example and can be not greater than ⅛^{th} to about ¼ of the wavelength λ or minimum wavelength λ_{MIN} of the beam RB, and without being bound to theory is expected by the inventors to provide insignificant disruption to the beam RB.

The height dimension HD and the length dimension LD of the shield 10 are such as to ensure that the rods fully traverse the length and height of the cross-section of the channel CH in which the shield 10 is placed. This is done such as to ensure that the radio beam RB passes through the rods 30 in a uniform manner when the radio beam RB is steered throughout the entirety of the azimuth and elevation ranges thereof. Without being bound to theory, inventors consider that as the electromagnetic waves of the radio beam RB pass through the rod arrangement of the shield, the phase of the beam changes, and thus such an arrangement in which the radio beam RB passes through the rods 30 in a uniform manner throughout the entirety of the azimuth and elevation ranges ensures that the electromagnetic waves of the radio beam RD are all in phase during such steering.

Referring also to FIGS. 2A, 3A, and 3B, the height dimension HD of the shield 10 is such that the top surface ST of the channel CH intersects the uppermost rod 30 of the shield 10 (marked in FIG. 3B as rod 30A) and the bottom surface SB is close to (or as close to as possible, or abutting, or intersecting) the lowermost rod 30 of the shield 10 (marked in FIG. 3B as rod 30B), and the length dimension LD is such that the right side surface SSR and the left side surface SSL each intersect all of the rods 30 of the shield. Thus, the beam RB essentially traverses the rods 30 of the shield 10 throughout the azimuth and elevation operating ranges of the scanning volume, and ensures that the planarity of the phase of the electromagnetic energy of the beam RB is maintained unchanged.

As disclosed above, the shield 10 comprises a plurality of rods 30, the rods 30 being in parallel spatial relationship one to another. By parallel arrangement is meant herein that the respective longitudinal axes LA are parallel to one another. Furthermore, as mentioned above, referring again to FIG. 4, the longitudinal axes LA of the plurality of rods 30 included in the shield 10 can be included fully in a single third plane P3, or can be divided into a number of groups wherein in each group the respective longitudinal axes LA are included in a respective third plane P3 of a plurality of mutually parallel third planes P3. The one or more respective third planes P3 is/are orthogonal to the first plane P1. In at least this example, the one or more respective third planes P3 is/are orthogonal to the horizontal plane HP.

In at least this example, the one or more respective third planes P3 is/are parallel to the front face FF of the antenna 100. However, in at least some alternative variations of this example, the one or more respective third planes P3 can be inclined with respect to the front face FF of the antenna.

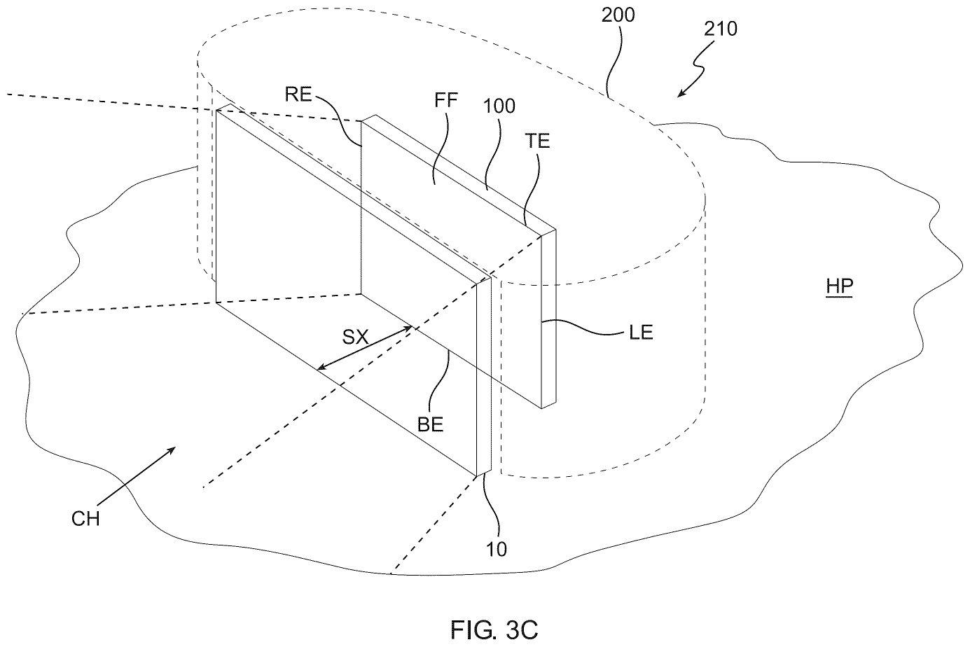

In one example of such an arrangement for the rods 30 in the shield 10, and referring to FIG. 5, the rods 30 are co-planarly arranged in spatial arrangement with respect to one another in frame 20 such that the longitudinal axes LA of all the rods 30 lie on a single third plane P3. In at least this example, the inter-rod center spacing IRC between adjacent longitudinal axes of each respective pair of adjacent rods 30 is in the order of ¼ of the respective operating wavelength λ (i.e., IRC @ 0.25*λ) for example between 0.2 and 0.3 of respective operating wavelength λ of the antenna 100. In applications of at least this example, in which the respective antenna 100 operates in an operating wavelength range Rλ, the inter-rod center spacing IRC between adjacent longitudinal axes of each respective pair of adjacent rods 30 is for example in the order of ¼ of the respective minimum wavelength λ_{MIN} of the respective operating wavelength range Rλ (i.e., IRC @ 0.25*λ_{MIN}) for example between 0.2 and 0.3 of respective operating minimum wavelength λ_{MIN}.

In at least some examples, the inter-rod center spacing is about 30 mm.

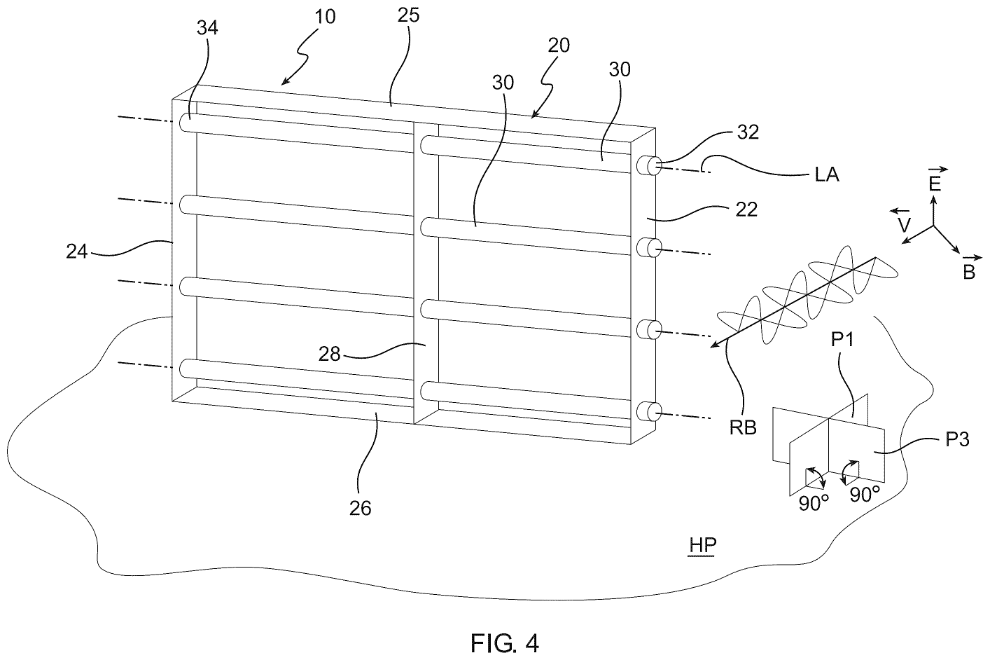

In another example of such an arrangement for the rods 30 in the shield 10, and referring to FIG. 6, the rods 30 are in spatial arrangement with respect to one another in frame 20 such that the plurality of rods 30 are divided into two groups, each group comprising an approximately equal number of rods 30. The rods 30 of the first group G_{A} are co-planarly arranged with respect to one another such that the longitudinal axes LA of all the respective rods 30 lie on a first third plane P3_{A}. The rods 30 of the second group G_{B} are arranged with respect to one another such that the longitudinal axes LA of all the respective rods 30 lie on a second third plane P3_{B}. The first third plane P3_{A} and the second third plane P3_{B} are parallel to one another, and spaced from one another by an inter-plane spacing IPS.

In at least this example, the inter-plane spacing IPS is in the order of ¼ of the respective operating wavelength λ (i.e., IRC @ 0.25*λ) for example between 0.2 and 0.3 of respective operating wavelength λ of the antenna 100. In applications of at least this example, in which the respective antenna 100 operates in an operating wavelength range Rλ, the inter-plane spacing IPS is for example in the order of ¼ of the respective minimum wavelength λ_{MIN} of the respective operating wavelength range Rλ (i.e., IRC @ 0.25*λ_{MIN}) for example between 0.2 and 0.3 of respective operating minimum wavelength λ_{MIN}.

In at least some examples, the inter-plane spacing IPS is about 30 mm.

In at least this example, the inter-rod center spacing IRC between adjacent longitudinal axes of each respective pair of adjacent rods 30 in each one of the first group G_{A} and the second group G_{B} is in the order of ¼ of the respective operating wavelength λ (i.e., IRC @ 0.25*λ) for example between 0.2 and 0.3 of respective operating wavelength λ of the antenna 100. In applications of at least this example, in which the respective antenna 100 operates in an operating wavelength range Rλ, the inter-rod center spacing IRC between adjacent longitudinal axes LA of each respective pair of adjacent rods 30 in each one of the first group G_{A} and the second group G_{B} is in the order of ¼ of the respective minimum wavelength λ_{MIN} of the respective operating wavelength range Rλ (i.e., IRC @ 0.25*λ_{MIN}) for example between 0.2 and 0.3 of respective operating minimum wavelength λ_{MIN}.

In at least this example, the rods 30 of the first group G_{A} and the rods 30 of the second group G_{B} are staggered arrangement in a direction parallel to the first third plane P3_{A} and the second third plane P3_{B}, this direction also being orthogonal to the respective longitudinal axes LA. In at least this example, such a direction is also nominally or generally vertical, when the shield 10 is installed with respect to the antenna 100.

In the aforesaid staggered arrangement, each of the rods 30 of the first group G_{A} are intercalated with respect to an adjacent pair of rods 30 of the second group G_{B}. Thus, in a direction parallel to the first third plane P3_{A} and the second third plane P3_{B}, and orthogonal to the respective longitudinal axes LA, the respective longitudinal axis LA of each rod of the first group G_{A} is spaced from the longitudinal axis LA of an adjacent rod 30 of the second group G_{B} by an intercalated spacing ICS. In at least this example, the intercalated spacing ICS is nominally half of the inter-rod center spacing IRC.

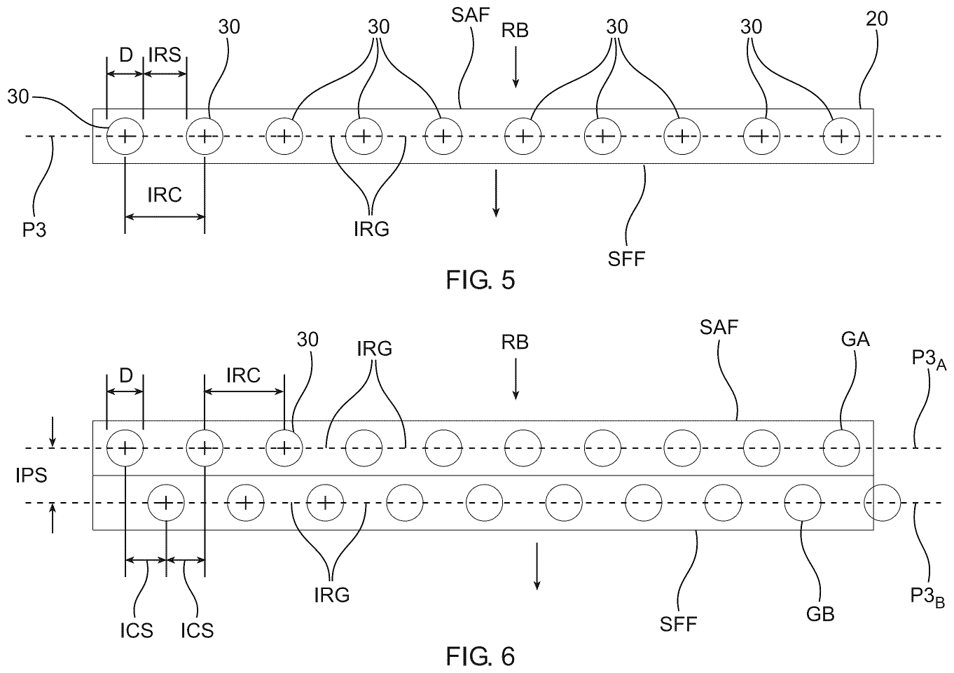

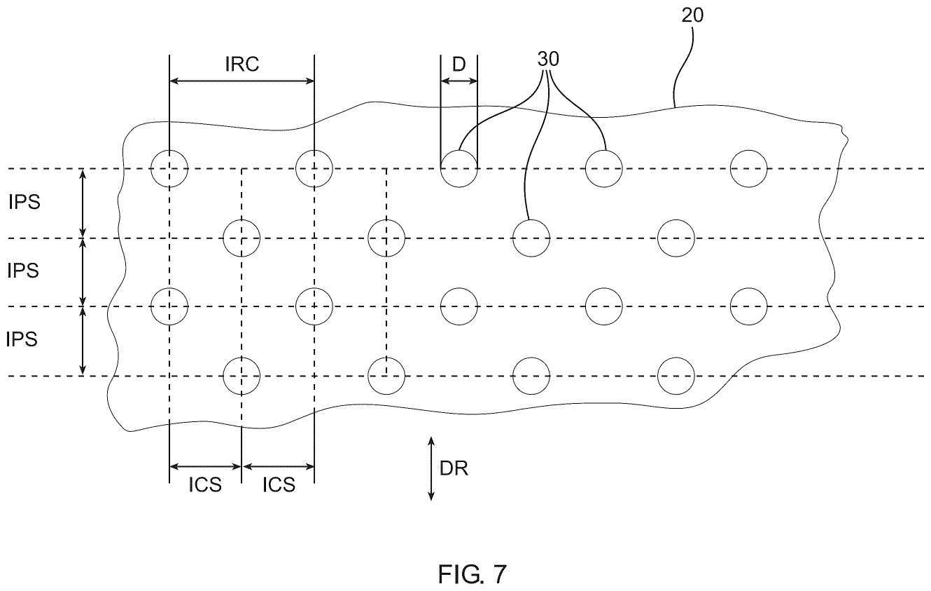

In yet other example of such an arrangement for the rods 30 in the shield 10, and referring to FIG. 7 and FIG. 8, the rods 30 are in spatial arrangement with respect to one another in frame 20 such that the plurality of rods 30 are divided into three groups or four groups, or more than four groups. Each such group comprises an approximately equal number of rods 30 co-planarly arranged in a similar to the examples of FIG. 5 or FIG. 6, mutatis mutandis. Thus, in each respective group, the respective rods thereof are aligned on a respective third plane P3, and spaced from one another by a respective inter-rod center spacing IRC, the third planes P3 of each pair of adjacent third planes being spaced from one another by a respective inter-plane spacing IPS.

Furthermore, the rods 30 of each serially successive group of rods is staggered with respect to rods of at least the next adjacent group, in the forward or aft direction.

In one example of such staggering, and referring to FIG. 7 in particular, each of the rods 30 of one group are intercalated with respect to an adjacent pair of rods 30 of an adjacent group. Thus, in a direction DR parallel to the respective third planes P3 and orthogonal to the respective longitudinal axes LA, the respective longitudinal axis LA of each rod of one such group is spaced from the longitudinal axis LA of an adjacent rod 30 of the adjacent group by an intercalated spacing ICS. In at least this example (and in the example of FIG. 6) the intercalated spacing ICS is nominally half of the inter-rod center spacing IRC. Thus, in the example of FIG. 7, the stagger pattern essentially repeats every two adjacent groups, and multiple rods 30 from every other group are aligned along this direction DR.

In another example of such staggering, and referring to FIG. 8 in particular, the rods 30 of each successive group are progressively intercalated with respect to an adjacent pair of rods 30 of an adjacent group, in an aft to forward direction along a direction DR. As before, direction DR is parallel to the respective third planes P3 and orthogonal to the respective longitudinal axes LA. In each successive group, the respective longitudinal axis LA of each rod thereof is spaced from the longitudinal axis LA of an adjacent rod 30 of the adjacent group by an intercalated spacing ICS. In at least this example, the intercalated spacing ICS is nominally a fraction 1/n of the inter-rod center spacing IRC. If there are three or more such groups, “n” can be an integer at least equal to 3, and thus the intercalated spacing ICS is ⅓ of the inter-rod center spacing IRC. In the illustrated example of FIG. 8, there are four such groups, and n has an integer value of 4, such that the intercalated spacing ICS is ¼ of the inter-rod center spacing IRC.

Depending on the relative sizes of the respective baseline height dimension or baseline diameter D, the intercalated spacing ICS and the inter-rod center spacing IRC, of the multi-group examples of FIGS. 6, 7, 8, the respective staggered arrangement collectively provides a solid or semi-solid wall of rods orthogonal to the direction DR, i.e., when viewed along the direction DR, thereby essentially covering the inter-rod gaps IRG of one group of rods by the rods of one or more successive groups of rods.

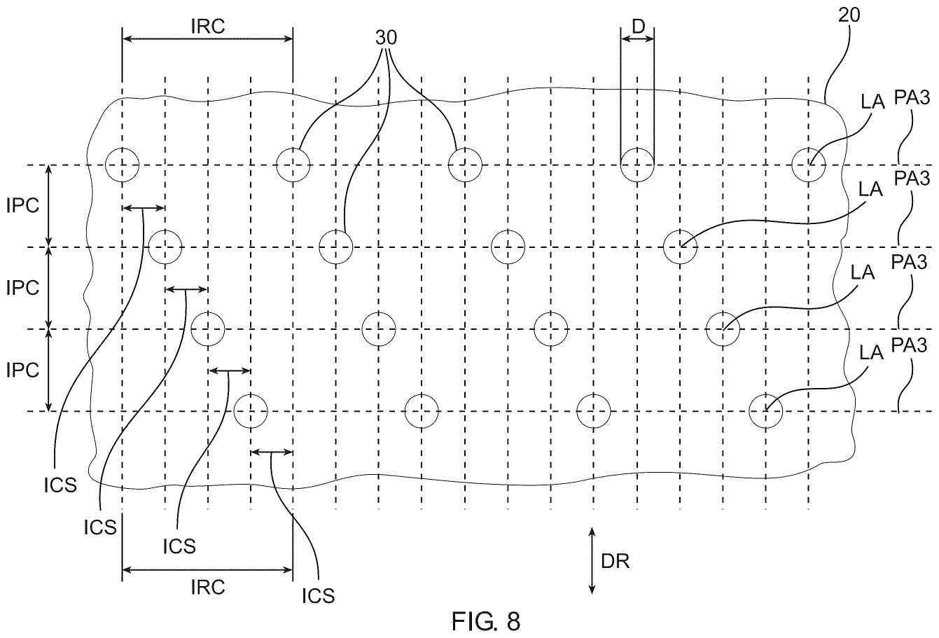

In at least some example, and referring to FIG. 9, the respective shield comprises one or more dielectric sheets 40, in nominally parallel relationship with respect to the one or more third planes P3.

The dielectric sheets 40 are configured for providing a level of protection to the antenna 100 for the effects of an impact on the shield 10. For example, the dielectric sheets are about 1 mm thick and made from polycarbonate materials.

While in at least the example of FIG. 9, two dielectric sheets 40 are provided, one at the forward face SFF and the other at the aft face SAF of the shield 10, in at least some alternative variations of this example, a single dielectric sheet can be provided either at the forward face SFF or at the aft face SAF of the shield 10. While in the example of FIG. 9 two groups of rods are illustrated, similar to the example of FIG. 6, it is contemplated that the one or two dielectric sheets, forward and/or aft of the shield, can be provided for any example of the shield, for example comprising a single group of rods (for example similar to but not limited to the example of FIG. 5), or for examples having multiple groups of rods (for example similar to but not limited to the examples of FIG. 7 or 8).

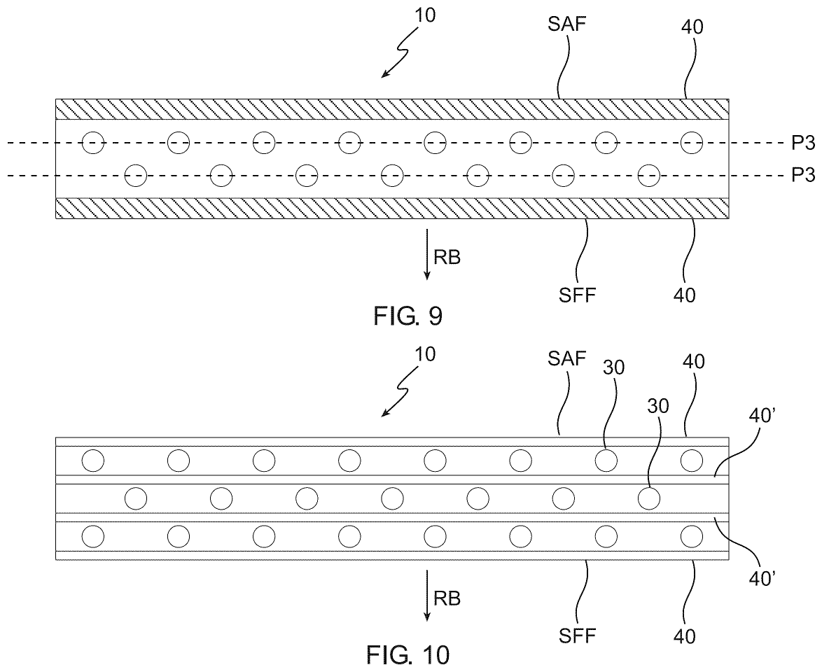

Optionally, and as illustrated in FIG. 10, additional intermediate dielectric sheets 40′ can be provided within the shield 10, for example in the spacing between adjacent groups of rods.

In at least some alternative variations of the example of FIG. 10, the dielectric sheets 40 at the forward face SFF and at the aft face SAF of the shield 10 can be omitted, leaving only one or more intermediate dielectric sheets 40′. In at least some other alternative variations of the example of FIG. 10, the dielectric sheets 40 at the forward face SFF or at the aft face SAF of the shield 10 can be omitted, leaving the other external dielectric sheet plus one or more intermediate dielectric sheets 40′.

In at least some examples, the respective frame member 20 can be provided exclusively by one or more dielectric sheets 40 and/or intermediate dielectric sheets 40′, which provide the necessary mechanical support for the rods 30, which are secured thereto.

In at least some alternative variations of the examples of FIGS. 5 to 10, the entire spacing between the rods can be filled with a dielectric substance for example a solid foam, for example rohacell foam or polystyrene foam. In at least the examples of FIGS. 9 and 10, the dielectric sheets 40 at the forward face SFF and at the aft face SAF of the shield 10, and/or one or more intermediate dielectric sheets 40′, can be omitted or can be retained. In at least some alternative variations of the above examples, the rods 30 are affixed to the frame 20 via a shock absorber arrangement. In at least one example of such a shock absorber arrangement, the longitudinal ends of the rods 30 are accommodated in oversized openings in the frame 20, and the spacing between the rod longitudinal ends and the respective overused openings are filled with a dampening material. In this manner, when the rods 30 are impacted by a threat, such an impact can be dampened by the shock absorber arrangement.

In operation of the antenna 100 with the shield 10 installed forward of the forward face FF, the radio beam RB is emitted from and exits the antenna 100 and passes through the shield 10 with little or no interference of the amplitude, frequency, or intensity of the radio beam RB.

Without being bound to theory, inventors consider that the electromagnetic waves of the radio beam RB, when encountering the curved rods 30, act like creeping waves and essentially creep around the rods 30 from one diametric end thereof facing the antenna 10, to the other end thereof facing away from the antenna 100, and then continues along the steered direction after exiting the shield 10.

As disclosed above, and referring again to FIG. 2B, each rod 30 also has a curved transverse cross-section CC. While by “curved” is meant herein to refer being smoothly rounded in a convex manner, and having a single or multiple centers of curvature, the term “curved” also includes herein high-sided polygonal shapes, having a large number of sides (as well as relatively large angles defined at all the polygon corners) to resemble a curved shape, and such that provides a similar creeping wave effect to the electromagnetic waves emitted/received by the antenna. For example, the number of sides can be greater than 8, and the angles at the corners can exceed 140°, and thus includes for example regular polygons such as for example nonagons, decagons and so on up to chiliagon (having a thousand sides), or polygons with more than one thousand sides.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes can be made therein without departing from the spirit of the presently disclosed subject matter.

1. A shield for an antenna, the shield comprising:
a plurality of rods, each of the plurality of rods having at least an external surface made from an electrical conducting material;
wherein the plurality of rods are in parallel spatial relationship one to another, the plurality of rods each having a respective curved transverse cross-section.

2. The shield according to claim 1, wherein the external surface covers a dielectric core.

3. The shield according to claim 1, wherein the plurality of rods are made from the same or different said electrical conducting material.

4. The shield according to claim 1, wherein the shield is in a form of a parallelepiped, having a forward face and an aft face, the shield having a lateral length dimension, a height dimension, and a thickness dimension.

5. The shield according to claim 1, wherein, in said parallel spatial relationship, the plurality of rods are spaced from one another by respective gaps, wherein said inter rod gaps are empty.

6. The shield according to claim 1, including at least one of the following:
wherein in said parallel spatial relationship the plurality of rods are spaced from one another by respective gaps, and wherein said gaps are filled, partially or fully, with a suitable dielectric material;
wherein the longitudinal axes of the respective said rods accommodated in the shield are fully included in planar aligned arrangement with respect to a single plane;
wherein the longitudinal axes of the respective said rods accommodated in the shield are fully included in planar aligned arrangement with respect to a single plane, and, wherein the single plane is orthogonal to a propagation direction of an electromagnetic beam transmitted and/or received by the antenna at zero azimuth and 0° elevation;
wherein the longitudinal axes of the respective said rods accommodated in the shield are fully included in planar aligned arrangement with respect to a single plane, and, wherein in said single plane an inter-rod center spacing between adjacent longitudinal axes of each respective pair of adjacent rods is in the order of ¼ of the respective operating minimum wavelength of the antenna, and wherein optionally the inter-rod center spacing is about 30 mm;
wherein the longitudinal axes of the respective said rods accommodated in the shield are fully included in planar aligned arrangement with respect to a single plane, and, wherein the single plane is orthogonal to a propagation direction of an electromagnetic beam transmitted and/or received by the antenna at zero azimuth and 0° elevation, and, wherein in said single plane an inter-rod center spacing between adjacent longitudinal axes of each respective pair of adjacent rods is in the order of ¼ of the respective operating minimum wavelength of the antenna, and wherein optionally the inter-rod center spacing is about 30 mm; or
wherein the longitudinal axes of the respective said rods accommodated in the shield are divided into a number of groups, wherein in each said group the respective longitudinal axes are included in planar aligned arrangement with respect to a respective plane of a plurality of mutually parallel planes.

7. The shield according to claim 1, wherein each of said plurality of rods is elongate and extends rectilinearly along a respective longitudinal axis between a respective first longitudinal end and a respective second longitudinal end, and wherein optionally in said parallel relationship, the respective longitudinal axes of the plurality of rods are parallel to one another.

8. The shield according to claim 1, wherein each said curved transverse cross-section has a baseline height dimension.

9. The shield according to claim 8, including at least one of the following:
wherein each said curved transverse cross-section is circular, and wherein the baseline height dimension is a baseline diameter of the transverse cross-section, or, wherein each said curved transverse cross-section is egg-shaped oval or elliptical, and wherein the baseline height dimension is a dimension of a respective minor axis of the respective egg-shaped oval or elliptical transverse cross-section;
wherein all the plurality of rods comprised in the shield have the same cross-sectional baseline height dimensions;
including one of the following: wherein an operating frequency of the antenna is 2.4 gigahertz, and wherein the baseline height dimension is about 12 mm, or about 16 mm, or in the range 12 mm to 16 mm; wherein an operating frequency of the antenna is 4.8 gigahertz, and wherein the baseline height dimension is about 6 mm, or about 8 mm, or in the range 6 mm to 8 mm;
wherein said baseline height dimension is significantly greater than 1/20^{th} of the respective operating minimum wavelength of the antenna; or
wherein said baseline height dimension is less than or about ⅛^{th} or less than a respective operating minimum wavelength of the antenna, and wherein said baseline height dimension is greater than 1/20^{th} of the respective operating minimum wavelength of the antenna.

10. The shield according to claim 1, wherein each of said plurality of rods has a uniform said transverse cross-section along the length thereof.

11. The shield according to claim 1, including one of the following:
wherein said plurality of rods are made from one or more materials and are so dimensioned and so shaped so as to together provide physical characteristics sufficient such as to provide mechanical protection to the antenna when the shield is interposed between the antenna and a source of an in-coming threat; or
wherein said plurality of rods are made from one or more materials and are so dimensioned and so shaped so as to together provide physical characteristics sufficient such as to provide mechanical protection to the antenna when the shield is interposed between the antenna and a source of an in-coming, and, wherein said physical characteristics include one or more of: mechanical strength, ductility, toughness, thickness, or density of the material.

12. The shield according to claim 1, including at least one of the following:
wherein said plurality of rods are made from a mechanically resistant metal; or
wherein said plurality of rods are made from or comprise any one of or combination of: steel, stainless steel, tungsten, chromium, titanium, or iron.

13. The shield according to claim 1, wherein in said parallel spatial relationship the plurality of rods are spaced from one another by respective gaps, and wherein said gaps are filled, partially or fully, with a suitable dielectric material, and wherein the longitudinal axes of the respective said plurality of rods accommodated in the shield are divided into a number of groups, wherein in each said group the respective longitudinal axes are included in planar aligned arrangement with respect to a respective plane of a plurality of mutually parallel planes, and including at least one of the following:
wherein each said respective plane is orthogonal to a propagation direction of an electromagnetic beam transmitted and/or received by the antenna at zero azimuth and 0° elevation;
wherein in said respective plane an inter-rod center spacing between adjacent longitudinal axes of each respective pair of adjacent rods is in the order of ¼ of the respective operating minimum wavelength of the antenna, and wherein optionally the inter-rod center spacing is about 30 mm;
wherein each pair of adjacent said planes are spaced from one another by an inter-plane spacing, and wherein the inter-plane spacing is in the order of ¼ of the respective operating minimum wavelength of the antenna;
wherein the inter-plane spacing is about 30 mm;
wherein for each pair of adjacent said planes, the respective rods of one said adjacent plane are in staggered arrangement with respect to the respective rods of the other said adjacent plane;
wherein for each pair of adjacent said planes, the respective rods of one said adjacent plane are in staggered arrangement with respect to the respective rods of the other said adjacent plane, and, including one of the following:
wherein in said staggered arrangement, each of the plurality of rods of one said adjacent plane are intercalated with respect to an adjacent pair of said rods of the other said adjacent plane; or
wherein in said staggered arrangement, each of the plurality of rods of one said adjacent plane are intercalated with respect to an adjacent pair of said rods of the other said adjacent plane by an intercalation spacing equal to half of the inter-rod center spacing between adjacent longitudinal axes of each respective pair of adjacent rods; wherein in said staggered arrangement, each of the plurality of rods of one said adjacent plane are intercalated with respect to an adjacent pair of said rods of the other said adjacent plane by an intercalation spacing less than half of the inter-rod center spacing between adjacent longitudinal axes of each respective pair of adjacent rods.

14. The shield according to claim 1, including one of the following:
the shield comprising a frame structure configured for mechanically fixing the plurality of rods in said parallel spatial relationship one to another;
the shield comprising a frame structure configured for mechanically fixing the plurality of rods in said parallel spatial relationship one to another, and, wherein the frame structure includes a first frame member laterally spaced from a second frame member, each in orthogonal relationship with respect to the respective longitudinal axes of the plurality of rods, and wherein the plurality of rods are mechanically fixed to the first frame member via the respective first longitudinal ends of the plurality of rods, and wherein the plurality of rods are mechanically fixed to the second frame member via the respective second longitudinal ends of the plurality of rods;
the shield comprising a frame structure configured for mechanically fixing the plurality of rods in said parallel spatial relationship one to another, and, wherein the frame structure includes a first frame member laterally spaced from a second frame member, each in orthogonal relationship with respect to the respective longitudinal axes of the plurality of rods, and wherein the plurality of rods are mechanically fixed to the first frame member via the respective first longitudinal ends of the plurality of rods, and wherein the plurality of rods are mechanically fixed to the second frame member via the respective second longitudinal ends of the plurality of rods, and, wherein the frame structure further comprises a top frame member and a bottom frame member, each joined at respective lateral ends thereof to the first frame member and the second frame member;
the shield comprising a frame structure configured for mechanically fixing the plurality of rods in said parallel spatial relationship one to another, and, wherein the frame structure includes a first frame member laterally spaced from a second frame member, each in orthogonal relationship with respect to the respective longitudinal axes of the plurality of rods, and wherein the plurality of rods are mechanically fixed to the first frame member via the respective first longitudinal ends of the plurality of rods, and wherein the plurality of rods are mechanically fixed to the second frame member via the respective second longitudinal ends of the plurality of rods, and, wherein the frame structure further comprises a top frame member and a bottom frame member, each joined at respective lateral ends thereof to the first frame member and the second frame member, and, wherein the frame structure comprises one or more thin cross-sectioned intermediate vertical members, each said thin cross-sectioned intermediate vertical member linking the top frame member and the bottom frame member to one another;
the shield comprising a frame structure configured for mechanically fixing the plurality of rods in said parallel spatial relationship one to another, and, wherein the frame structure is made from any suitable dielectric material or from a metal; or
the shield comprising a frame structure configured for mechanically fixing the plurality of rods in said parallel spatial relationship one to another, and, wherein the plurality of rods are mounted to the frame via a first shock absorber arrangement.

15. The shield according to claim 1, including at least one of the following:
wherein the shield comprises one or more dielectric sheets, in nominally parallel relationship with respect to a forward face of the shield, the one or more dielectric sheets being configured for providing a level of protection to the antenna, and optionally comprising at least one of the following: one said dielectric sheet affixed to the forward face; one said dielectric sheet fixed to an aft face of the shield; at least one said dielectric sheet fixed within the shield;
wherein the shield comprises a foam material filling spaces between the plurality of rods.

16. An antenna installation, comprising:
an antenna having a forward antenna face for emitting and/or receiving electromagnetic radiation; and
a shield as defined in claim 1, spaced forward of said forward antenna face by a forward spacing.

17. The antenna installation according to claim 16, wherein the shield is operative for providing protection to the antenna for threats originating in a direction towards the forward antenna face, wherein said direction is included within a channel defined by a respective maximum azimuth range and a maximum elevation range of the antenna.

18. The antenna installation according to claim 17, including at least one of the following:
wherein the respective maximum azimuth range is ±60°, and the respective maximum positive elevation of the antenna is ±60°;
wherein the channel diverges and increases a cross-sectional area thereof in a forward direction away from the forward antenna face;
wherein a height dimension of the shield and the length dimension of the shield are such as to ensure that the respective rods fully traverse a length and a height of a cross-section of the channel corresponding to a location of the shield in the channel;
wherein the channel is defined by a top surface, a bottom surface, a right side surface and a left side surface, wherein a height dimension of the shield is such that the top surface of the channel intersects an uppermost said rod of the shield, and such that the bottom surface of the channel is any one close to abutting, or intersecting, a lowermost said rod of the shield, and wherein a length dimension of the shield is such that the right side surface and the left side surface of the channel each intersect all of the plurality of rods of the shield;
including a protection structure configured for providing at least protection from a threat having a trajectory towards the antenna that avoids crossing into the channel and that is towards the antenna, and wherein optionally the protection structure comprises a peripheral wall and a top wall; or
including a protection structure configured for providing at least protection from a threat having a trajectory towards the antenna that avoids crossing into the channel and that is towards the antenna, and wherein optionally the protection structure comprises a peripheral wall and a top wall, and, comprising a second shock absorber arrangement interconnecting the shield to the protection structure.

19. The antenna installation according to claim 16, including at least one of the following:
wherein the antenna is any one of: a static phased array antenna; a static radio antenna or a static TV antenna; a revolving antenna, in which the shield is mechanically coupled to the antenna, and wherein the shield and the antenna revolve as a unit about the rotation axis of the antenna;
wherein the antenna is any one of: a passive electronic scanned array (PESA); an active electronically scanned array (AESA); a hybrid beam forming phased array; a digital beam forming (DBF) array; or a conformal antenna in which individual antennas are arranged on a curved surface, and phase shifters operate to enable the conformal antenna to generate a plane wave;
wherein the antenna is operative to generate a steerable radio beam having a propagation direction, the radio beam having an oscillating electric field along an electric field plane, and wherein said longitudinal axes of the respective rods are non-parallel with respect to the electric field plane; or
wherein the antenna is operative to generate a steerable radio beam having a propagation direction, the radio beam having an oscillating electric field along an electric field plane, and wherein said longitudinal axes of the respective rods are non-parallel with respect to the electric field plane, and, wherein said radio beam is operable at a radio frequency range in any one or more of the X-band, S-band, C-band, or L-band.

20. A method for protecting an antenna, the antenna having a forward antenna face for emitting and/or receiving electromagnetic radiation, the method comprising:
(I) providing the shield as defined in claim 1,
(II) spacing the shield forward of said forward face.
